(19) United States
(12) Patent Application Publication
(10) Pub. No.: US 2024/0427036 A1
(43) Pub. Date: Dec. 26, 2024

(54) LEARNING DEVICE AND NEUTRON MEASUREMENT DEVICE

(71) Applicant: Mitsubishi Electric Corporation, Chiyoda-ku, Tokyo (JP)

(72) Inventors: Tetsushi AZUMA, Chiyoda-ku, Tokyo (JP); Makoto SASANO, Chiyoda-ku, Tokyo (JP)

(73) Assignee: Mitsubishi Electric Corporation, Chiyoda-ku, Tokyo (JP)

(21) Appl. No.: 18/702,596

(22) PCT Filed: Mar. 2, 2022
(86) PCT No.: PCT/JP2022/008785

§ 371 Date: Apr. 18, 2024

(51) Int. Cl. G01T 3/00; G01T 7/00

(52) U.S. Cl. CPC G01T 3/008; G01T 7/00

(57) ABSTRACT

Provided is a learning device for excluding a case where a pulse signal originating from a pile-up phenomenon is erroneously detected as a neutron. This learning device is a learning device that obtains a trained model for inferring a pulse origin which is an origin of a pulse signal in a neutron measurement device using a pulse measurement method, and includes: a training data acquisition unit which acquires training data including a pulse signal outputted from a detector which is an ionization chamber or a proportional counter; and a model generation unit which generates a trained model for inferring the pulse origin from the pulse signal outputted from the detector, using the training data.

Buchanan

### TECHNICAL FIELD

The present disclosure relates to a learning device and a neutron measurement device.

### BACKGROUND ART

A neutron measurement device used for monitoring a nuclear reactor output detects a neutron produced in a reactor core, in order to control and protect a nuclear reactor. Examples of neutron measurement methods for monitoring a nuclear reactor output include a pulse measurement method of counting the number of individual pulses of a detector signal, a Campbell measurement method of calculating a mean square value of a fluctuation component of a detector signal, and a current measurement method of obtaining a detector signal as DC current. In a pressurized water reactor (PWR), in order to monitor a nuclear reactor output, a neutron detector is provided outside a pressure vessel containing a reactor core equipped with nuclear fuel, to detect a neutron. In general, the nuclear reactor output changes over approximately eleven digits from start-up to a rated-output state. Therefore, for convenience in measurement, there are three regions defined: a region from start-up of the nuclear reactor to a comparatively low nuclear reactor output is a radiation source start-up region, a region around the rated output is an output region, and a region between the radiation source start-up region and the output region is an intermediate region. A neutron detector and a neutron measurement method corresponding to each region are used.

In the radiation source start-up region, a BF3 gas proportional counter tube, a nuclear fission ionization chamber, or the like are used as a neutron detector, and the pulse measurement method is used as a neutron measurement method. Among pulse signals which are outputs of the neutron detector, in general, a pulse height value of a pulse signal generated from a neutron is high and pulse height values of pulse signals generated from things other than a neutron are low. Therefore, in the radiation source start-up region, in order to remove the influence of radiation other than a neutron, which serves as a noise of a signal, pulse height discrimination processing using a difference between pulse height values of pulse signals is performed.

In the intermediate region, the current measurement method is used for a gamma-ray compensated B-10 coated ionization chamber and the pulse measurement method and the Campbell measurement method are used for a nuclear fission ionization chamber. Then, noise removing processing for reducing the influence of noise due to radiation other than a neutron from the reactor core is performed and a neutron is detected.

In the output region, a gamma-ray uncompensated B-10 coated ionization chamber or a nuclear fission ionization chamber is used as a neutron detector, and the current measurement method is used as a neutron measurement method. In the output region, the influence of a noise signal other than a neutron from the reactor core becomes relatively small, and therefore noise removing processing which would be performed in the radiation source start-up region or the intermediate region is not essential.

Here, in the pulse measurement method, while a pulse signal serving as a noise is removed by pulse height discrimination processing using a difference between pulse height values of pulse signals, if the generation frequency of pulse signals increases along with increase in the nuclear reactor output, two or more pulse signals overlap, so that only pulse height value is detected from a plurality of pulse signals, i.e., a pile-up phenomenon occurs. In the pulse height discrimination processing using a difference between pulse height values of pulse signals, a pulse signal due to a pile-up phenomenon is erroneously taken as a pulse signal based on a neutron. In the pulse measurement method using the pulse height discrimination processing, a pulse signal due to a pile-up phenomenon, which should be originally removed as a noise, is erroneously counted as the one based on a neutron, though the generation frequency might vary. Thus, the nuclear reactor output is indicated to be excessive. Therefore, the pile-up phenomenon is a factor of reducing reliability of a neutron detector using a pulse measurement method.

In order to prevent erroneous counting due to a pile-up phenomenon, proposed is a method in which a generation rate of a noise element due to a pile-up phenomenon is predicted in advance and a threshold for pulse height discrimination processing using a pulse height difference is set accordingly, thereby improving performance of the pulse height discrimination processing (see, for example, Patent Document 1).

### CITATION LIST

### Patent Document

Patent Document 1: Japanese Patent No. 5336934

### SUMMARY OF THE INVENTION

### Problem to be Solved by the Invention

In the neutron measurement device shown in Patent Document 1, the maximum value of a pulse signal due to a pile-up phenomenon of alpha rays as a noise is used for threshold determination, to remove a pulse signal that is a noise attributed to alpha rays. However, threshold determination is only for a superimposed signal generated by a pile-up phenomenon of alpha rays as assumed in advance. Among superimposed signals generated by a pile-up phenomenon of radiation other than a neutron, for example, a pulse height value of a superimposed signal generated by a pile-up phenomenon of a plurality of gamma rays or a pulse height value of a superimposed signal generated by a pile-up phenomenon of a combination of a gamma ray and an alpha ray is greater than a pulse height value of a superimposed signal generated by a pile-up phenomenon of alpha rays. Therefore, the neutron measurement device shown in Patent Document 1 has a problem that such superimposed signals are erroneously detected as neutrons.

The present disclosure has been made to solve the above problem, and an object of the present disclosure is to provide a learning device for excluding a case where a pulse signal originating from a pile-up phenomenon is erroneously detected as a neutron.

### Means to Solve the Problem

A learning device according to the present disclosure is a learning device that obtains a trained model for inferring a pulse origin which is an origin of a pulse signal in a neutron measurement device using a pulse measurement method, the learning device including: a data acquisition unit which acquires training data including the pulse signal outputted from a detector which is a nuclear fission ionization chamber or a proportional counter; and a model generation unit which generates the trained model for inferring the pulse origin from the pulse signal outputted from the detector, using the training data.

### Effect of the Invention

The learning device according to the present disclosure includes the data acquisition unit which acquires the training data including the pulse signal outputted from the detector, and the model generation unit which generates the trained model for inferring the pulse origin from the pulse signal outputted from the detector, using the training data. Thus, it is possible to exclude a case where a pulse signal originating from a pile-up phenomenon is erroneously detected as a neutron.

### BRIEF DESCRIPTION OF THE DRAWINGS

FIG. 1 is a block diagram showing the configuration of a neutron measurement device according to embodiment 1.

FIG. 2 illustrates neutron detection by a detector in embodiment 1.

FIG. 3 illustrates gamma-ray detection by a detector in embodiment 1.

FIG. 4 illustrates alpha-ray detection by a detector in embodiment 1.

FIG. 5 shows an example of a pulse signal outputted from a detector in embodiment 1.

FIG. 6 shows an example of a pulse signal due to a pile-up phenomenon, outputted from a detector, in embodiment 1.

FIG. 7 illustrates operation of a neutron measurement device in a comparative example.

FIG. 8 shows the relationship between a nuclear reactor output and neutron detection counting in the neutron measurement device.

FIG. 9 is a block diagram showing the configuration of a signal processing unit in embodiment 1.

FIG. 10 is a block diagram showing the configuration of a learning device in embodiment 1.

FIG. 11 illustrates an example of unsupervised learning in a model generation unit in embodiment 1.

FIG. 12 is a flowchart illustrating processing by the learning device and a trained-model storage unit in embodiment 1.

FIG. 13 is a block diagram showing the configuration of an inference device in embodiment 1.

FIG. 14 illustrates processing in an inference unit in embodiment 1.

FIG. 15 is a flowchart illustrating processing by the inference device, a counting device, and a host device in embodiment 1.

FIG. 16 shows a time at which a neutron due to nuclear fission in a nuclear reactor occurs.

FIG. 17 shows a time at which radiation other than a neutron in the nuclear reactor occurs.

FIG. 18 is a block diagram showing the configuration of a neutron measurement device according to embodiment 2.

FIG. 19 is a block diagram showing the configuration of a signal processing unit in embodiment 2.

FIG. 20 is a block diagram showing the configuration of a learning device in embodiment 2.

FIG. 21 illustrates an example of unsupervised learning in a model generation unit in embodiment 2.

FIG. 22 illustrates discrimination processing for pulse signals due to pile-up phenomena in the learning device in embodiment 2.

FIG. 23 is a block diagram showing the configuration of an inference device in embodiment 2.

FIG. 24 is a schematic diagram showing an example of a hardware configuration of the neutron measurement device according to each of embodiments 1 and 2.

### DESCRIPTION OF EMBODIMENTS

Hereinafter, a learning device and a neutron measurement device according to embodiments for carrying out the present disclosure will be described in detail with reference to the drawings. In the drawings, the same reference characters denote the same or corresponding parts.

### Embodiment 1

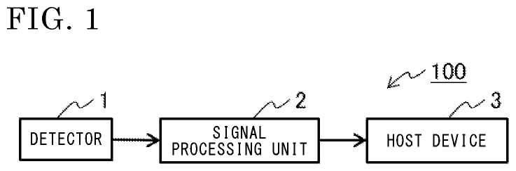

FIG. 1 is a block diagram showing the configuration of a neutron measurement device 100 according to embodiment 1. The neutron measurement device 100 includes a detector 1 for detecting a neutron from a nuclear reactor, a signal processing unit 2 which counts neutrons outputted from the detector 1 and outputs the count, and a host device 3 which receives the output from the signal processing unit 2. The host device 3 is a device for processing a count or a count rate of neutrons outputted from the signal processing unit 2. The host device 3 is, for example, a computer for nuclear reactor protection, a computer for nuclear reactor control, or a display device for nuclear reactor output monitoring. The neutron measurement device 100 measures a neutron using a pulse measurement method.

The detector 1 is an ionization chamber or a proportional counter, and detects a neutron from the nuclear reactor and outputs a pulse signal to the signal processing unit 2. The detector 1 has a substance having a great reaction cross-section with a thermal neutron having energy of about 0.025 eV among neutrons produced in the nuclear reactor, and is, for example, a nuclear fission ionization chamber whose inside is coated with an isotope U-235 of uranium which is a nuclear fuel substance, or a BF3 proportional counter including an isotope B-10 of boron.

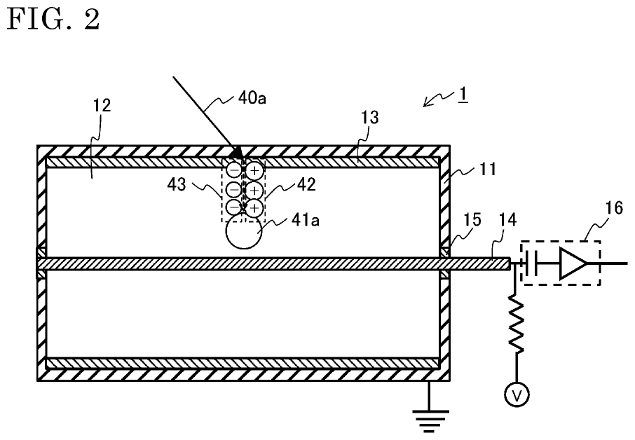

FIG. 2 illustrates neutron detection by the detector 1 in embodiment 1. The detector 1 shown in FIG. 2 is a nuclear fission ionization chamber. The inside of a detector housing 11 is filled with gas 12, and the detector housing 11 has a uranium-coated layer 13 on the inner side. An electrode 14 is connected to a power supply through a resistor, the detector housing 11 is grounded, and the electrode 14 and the detector housing 11 are insulated from each other by an insulator 15. Thus, high voltage is applied between the detector housing 11 and the electrode 14. An electronic circuit 16 is connected to the electrode 14, and the electronic circuit 16 includes a capacitor which shuts off DC voltage of the power supply connected to the electrode 14, and an amplifier for amplifying a signal.

When a neutron 40a enters the detector 1, a nuclear fission product 41a is produced at the uranium-coated layer 13, and along with this, an ion group 42 and an electron group 43 are produced. In a case where the detector 1 is the BF3 proportional counter, when the neutron 40a enters the detector 1, the nuclear fission product 41a is produced through nuclear reaction of the entering neutron 40a and B-10, and along with this, the ion group 42 and the electron group 43 are produced. The produced ion group 42 gathers at the detector housing 11 and the produced electron group 43 gathers at the electrode 14, whereby a pulse signal is outputted from the electronic circuit 16.

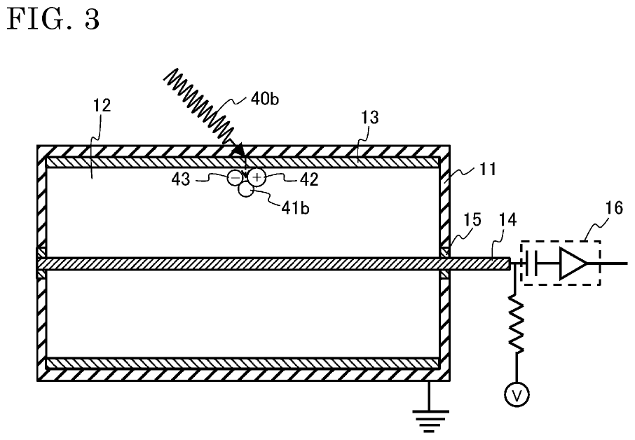

In principle, it is impossible for the detector 1 to detect the neutron 40a only, and the detector 1 detects also a gamma ray attributed to a nuclear fission product produced in the nuclear reactor or a gamma ray attributed to radio-activation of a structure around the nuclear reactor. FIG. 3 illustrates gamma-ray detection by the detector 1 in embodiment 1. FIG. 3 shows a scene in which a gamma ray 40b enters the detector 1 and an electron 41b, an ion group 42, and an electron group 43 are produced. Also in this case, a pulse signal is outputted from the electronic circuit 16.

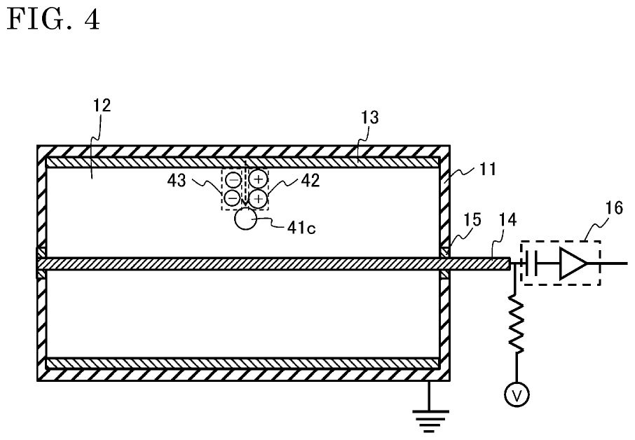

Further, in a case where the detector 1 is the nuclear fission ionization chamber, U-235 of the uranium-coated layer 13 on the inner side undergoes nuclear transmutation into a radioisotope that experiences alpha decay through nuclear reaction with a neutron, so that an alpha ray may be produced inside the detector 1. FIG. 4 illustrates alpha-ray detection by the detector 1 in embodiment 1. FIG. 4 shows a scene in which an ion group 42 and an electron group 43 are produced by an alpha ray 41c produced inside the detector 1. Also in this case, a pulse signal is outputted from the electronic circuit 16.

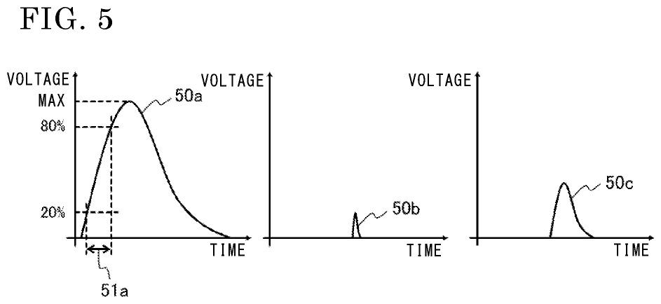

FIG. 5 shows an example of a pulse signal outputted from the detector 1 in embodiment 1. In FIG. 5, a left graph shows a pulse signal 50a based on neutron detection, outputted when a neutron has entered the detector 1, a center graph shows a pulse signal 50b based on gamma-ray detection, outputted when a gamma ray has entered the detector 1, and a right graph shows a pulse signal 50c based on alpha-ray detection, outputted when an alpha ray is produced inside the detector 1. In each graph shown in FIG. 5, the horizontal axis indicates time and the vertical axis indicates voltage. In a case where the detector 1 is the nuclear fission ionization chamber, the pulse signal 50a based on neutron detection originates from energy of about 200 MeV produced by nuclear fission reaction of U-235 and a neutron, and has a pulse height value attributed to energy of the produced nuclear fission product 41a. A pulse signal 50b based on gamma-ray detection is due to an electron 41b of several tens to several hundreds of keV produced through interaction between a gamma ray and the detector housing 11 or interaction between a gamma ray and the uranium-coated layer 13. The pulse height value of the pulse signal 50b based on gamma-ray detection is lower than the pulse height value of the pulse signal 50a based on neutron detection. Energy of the alpha ray 41c emitted by a radioisotope that experiences alpha decay and which is produced through nuclear reaction of a neutron and U-235 of the uranium-coated layer 13 is about 5 MeV, and the pulse height value of the pulse signal 50c based on alpha-ray detection is about several % of the pulse height value of the pulse signal 50a based on neutron detection.

As described above, among pulse height values of pulse signals, the pulse height value of the pulse signal 50a based on neutron detection is highest, the pulse height value of the pulse signal 50c based on alpha-ray detection is second highest, and the pulse height value of the pulse signal 50b based on gamma-ray detection is lowest.

A pulse signal based on neutron detection in a case where the detector 1 is the BF3 proportional counter has a pulse height value originating from energy of 2.7 MeV at maximum based on nuclear reaction of B-10 and a neutron. The pulse height value of a pulse signal based on gamma-ray detection in the case where the detector 1 is the BF3 proportional counter is the same as in a case where the detector 1 is the nuclear fission ionization chamber. In the case where the detector 1 is the BF3 proportional counter, a radioisotope that experiences alpha decay as in the nuclear fission ionization chamber is not produced and therefore a pulse signal based on alpha-ray detection is not outputted.

In a case of using a circuit that integrates an electric charge in the electronic circuit 16, a rising period of a pulse signal differs depending on an origin that causes the pulse signal. The rising period is defined as a time taken to rise from 20% to 80% of the maximum value of the pulse signal, for example. In the left graph in FIG. 5, a rising period 51a of the pulse signal 50a based on neutron detection is shown. In a case where the detector 1 is the nuclear fission ionization chamber, the gas 12 stored inside is ionized by the nuclear fission product 41a produced through nuclear reaction of the neutron 40a and U-235, the electron 41b produced through interaction originating from the gamma ray 40b, or the alpha ray 41c emitted by a radioisotope that experiences alpha decay and which is produced at the uranium-coated layer 13, and a range where the ionization occurs differs depending on an origin. As a result, the rising periods of pulse signals are different among the pulse signal 50a based on neutron detection, the pulse signal 50b based on gamma-ray detection, and the pulse signal 50c based on alpha-ray detection, and thus the rising period of each pulse signal also includes information unique to radiation that is an origin thereof.

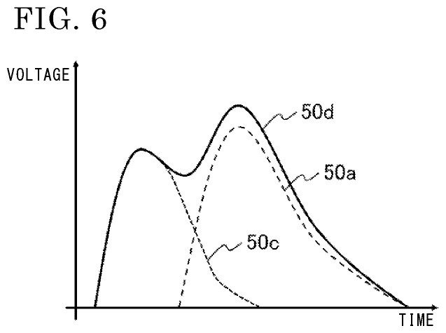

Pulse signals to be outputted from the detector 1 include not only the pulse signal 50a based on neutron detection, the pulse signal 50b based on gamma-ray detection, and the pulse signal 50c based on alpha-ray detection, but also a pulse signal due to a pile-up phenomenon. FIG. 6 shows an example of a pulse signal due to a pile-up phenomenon, outputted from the detector 1. The pile-up phenomenon is such a phenomenon that pulse signals based on neutron detection or pulse signals based on detection of radiation other than a neutron arise at the same time or almost at the same time, so that a superimposed signal in which a plurality of pulse signals are superimposed is outputted. The superimposition ratio increases with increase in the output of the nuclear reactor. FIG. 6 shows an example of a pulse signal 50d due to a pile-up phenomenon in which the pulse signal 50c based on alpha-ray detection and the pulse signal 50a based on neutron detection are superimposed. The number of pulse signals to be superimposed and the timing at which a plurality of pulse signals are superimposed are not uniquely determined.

The pulse signal 50d due to a pile-up phenomenon is roughly classified into a signal in which only a plurality of the pulse signals 50a based on neutron detection are superimposed, a signal in which the pulse signal 50a based on neutron detection and the pulse signal 50b based on gamma-ray detection are superimposed, and a signal in which only a plurality of the pulse signals 50b based on gamma-ray detection are superimposed. In a case where the detector 1 is the nuclear fission ionization chamber, there is also a signal in which only a plurality of the pulse signals 50c based on alpha-ray detection are superimposed.

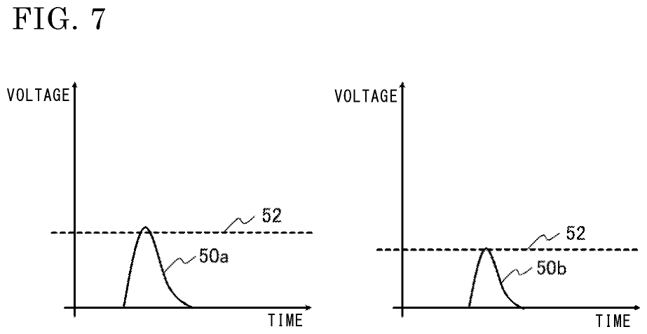

FIG. 7 illustrates operation of a neutron measurement device in a comparative example. The neutron measurement device in the comparative example includes the same detector 1 as in the neutron measurement device 100 according to embodiment 1 shown in FIG. 1. In a signal processing unit of the neutron measurement device in the comparative example, in order to selectively count the pulse signal 50a based on neutron detection, for example, as shown in FIG. 7, a pulse signal whose pulse height value exceeds a predetermined threshold 52 is determined to be the one originating from a neutron. Here, the threshold 52 is arbitrarily set as an adjustment element in measurement, and is set at, for example, a value smaller than the minimum value of the pulse height value of the pulse signal 50a based on neutron detection, as shown in a left graph in FIG. 7. In a case where the detector 1 is the BF3 proportional counter, the threshold 52 may be set at the maximum value of the pulse height value of the pulse signal 50b based on gamma-ray detection for radiation other than a neutron, as shown in a right graph in FIG. 7, for example. In a case where the detector 1 is the nuclear fission ionization chamber, the threshold 52 may be set at the maximum value of the pulse height value of the pulse signal 50c based on alpha-ray detection.

It is assumed that a pulse signal due to a pile-up phenomenon is inputted to the signal processing unit of the neutron measurement device in the comparative example and the pulse signal due to the pile-up phenomenon is a signal in which only a plurality of the pulse signals 50a based on neutron detection are superimposed. In this case, the pulse signal due to the pile-up phenomenon is counted as the pulse signal 50a based on detection for one neutron. As a result, counting is missed for the pulse signals 50a based on neutron detection, so that a count less than the actual number of neutrons is outputted. In addition, for example, in a case where a pulse signal due to a pile-up phenomenon is a signal in which only a plurality of the pulse signals 50b based on gamma-ray detection are superimposed, and thus the pulse height value thereof exceeds the threshold 52, or in a case where a pulse signal due to a pile-up phenomenon is a signal in which only a plurality of the pulse signals 50c based on alpha-ray detection are superimposed, and thus the pulse height value thereof exceeds the threshold 52, the pulse signal due to a pile-up phenomenon is counted as the pulse signal 50a based on detection for one neutron, so that a count more than the actual number of neutrons is outputted. In any case, reliability of the neutron measurement device in the comparative example is reduced.

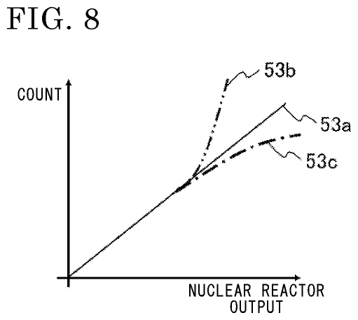

One reason for reduction in reliability of the neutron measurement device in the comparative example is that not only a neutron but also radiation other than a neutron increases along with output increase in the nuclear reactor, so that a pile-up phenomenon occurs. FIG. 8 shows the relationship between the nuclear reactor output and a count of neutron detection in the neutron measurement device. In a case where measurement is appropriately performed in the neutron measurement device, the nuclear reactor output and a count of neutrons exhibit linearity as shown by a line 53a. In the neutron measurement device in the comparative example, in a case where a larger amount of radiation other than a neutron is present than neutrons, as the output of the nuclear reactor increases, pulse signals based on detection of radiation other than a neutron are superimposed to be a superimposed signal by a pile-up phenomenon, so that the count becomes excessive. As a result, linearity between the nuclear reactor output and the count of neutrons is lost as shown by a curve 53b. Meanwhile, in a case where there is a small amount of radiation other than a neutron, only pulse signals based on neutron detection are superimposed, so that the count decreases. As a result, linearity between the nuclear reactor output and the count of neutrons is lost as shown by a curve 53c.

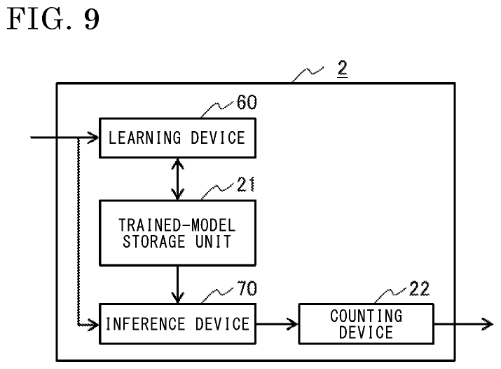

Next, the signal processing unit 2 of the neutron measurement device 100 according to embodiment 1 will be described. The signal processing unit 2 outputs a count of pulse signals based on neutrons detected within a predetermined measurement period. In a predetermined measurement interval, the signal processing unit 2 may output a value obtained by dividing a count of pulse signals based on neutrons within the time of the measurement interval by the measurement interval, as a count rate. FIG. 9 is a block diagram showing the configuration of the signal processing unit 2 in embodiment 1. The signal processing unit 2 includes a learning device 60, a trained-model storage unit 21, an inference device 70, and a counting device 22.

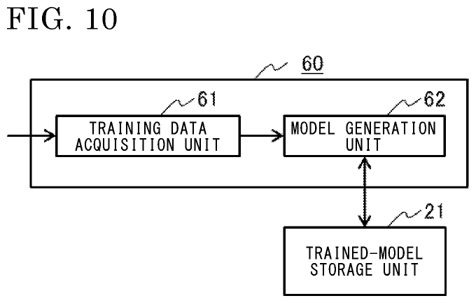

FIG. 10 is a block diagram showing the configuration of the learning device 60 in embodiment 1. The learning device 60 includes a training data acquisition unit 61 which acquires training data including pulse signals outputted from the detector 1 which is an ionization chamber or a proportional counter, and a model generation unit 62 which generates a trained model for inferring a pulse origin which is an origin of a pulse signal, from a pulse signal outputted from the detector 1, using the training data.

The training data acquisition unit 61 acquires a pulse signal that is an analog signal, outputted from the detector 1, and outputs a digital pulse signal obtained by converting the analog pulse signal to a digital signal, to the model generation unit 62. A time width for converting the analog signal to the digital signal may be a time width including the entirety of the acquired pulse signal, and is, for example, a time width including a range from a rising time at which the acquired pulse signal rises from zero to a termination time at which the pulse signal returns to zero. A time resolution for converting the analog signal to the digital signal may be a sufficient time resolution for generating a trained model in the model generation unit 62. Each pulse signal outputted from the detector 1 has a feature depending on an origin that causes the pulse signal. The training data acquisition unit 61 acquires training data including a pulse signal based on neutron detection, i.e., a pulse signal originating from a neutron, a pulse signal based on gamma-ray detection, i.e., a pulse signal originating from radiation other than a neutron, and a pulse signal due to a pile-up phenomenon, i.e., a pulse signal originating from a pile-up phenomenon. In a case where the detector 1 is the nuclear fission ionization chamber, the training data acquisition unit 61 acquires training data further including a pulse signal based on alpha-ray detection.

Using the training data outputted from the training data acquisition unit 61, the model generation unit 62 generates a trained model for inferring a pulse origin which is an origin of a pulse signal, from a pulse signal outputted from the detector 1. A learning algorithm used by the model generation unit 62 may be a known algorithm such as supervised learning, unsupervised learning, or reinforcement learning. As an example, a case of applying K-means clustering which is unsupervised learning will be described. The unsupervised learning is a method in which a learning device is provided with training data not including labels which are results and learns features present in the training data.

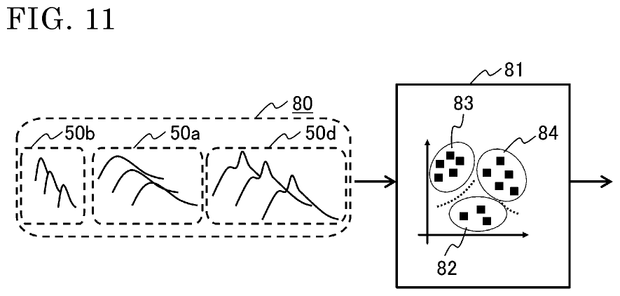

FIG. 11 illustrates an example of the unsupervised learning in the model generation unit 62 in embodiment 1. The trained model in embodiment 1 is for inferring, from a pulse signal outputted from the detector 1, a pulse origin which is an origin of the pulse signal, as any of a neutron, radiation other than a neutron, or a pile-up phenomenon. The model generation unit 62 learns origins of pulse signals through so-called unsupervised learning in accordance with a classification method by K-means clustering, for example. The K-means clustering is a non-hierarchical clustering algorithm in which given data are classified into k clusters using means of the clusters.

Specifically, in the K-means clustering, processing is performed through the following flow. First, a cluster is randomly allocated to each data xi. Next, a center Vj of each cluster is calculated on the basis of the allocated data. Next, the distance between each data xi and the center Vj is calculated, and each data xi is allocated again to the cluster whose center is closest thereto. Then, if there is no change in cluster allocation of all the data xi in the above processing or if the change amount is smaller than a certain threshold set in advance, the processing is determined to have reached convergence and thus is finished. The learning device 60 of embodiment 1 learns pulse origins which are origins of pulse signals through so-called unsupervised learning in accordance with the training data created on the basis of pulse signals acquired by the training data acquisition unit 61. In the learning device 60 of embodiment 1, for example, as shown in FIG. 11, pulse origins which are origins of pulse signals are learned through so-called unsupervised learning in accordance with training data 80 including pulse signals 50a based on neutron detection, pulse signals 50b based on gamma-ray detection, and pulse signals 50d due to a pile-up phenomenon, and are classified into three groups. Further, for example, simulation data of a pulse signal originating from a neutron is generated through numerical calculation reproducing the inside of the nuclear reactor, and the group to which the generated simulation data of the pulse signal is allocated when inputted to the trained model 81 is defined as a group 82 originating from a neutron. Further, simulation data of a pulse signal originating from a gamma ray may be generated through numerical calculation reproducing the inside of the nuclear reactor, and the group to which the generated simulation data of the pulse signal is allocated when inputted to the trained model 81 may be defined as a group 83 originating from radiation other than a neutron. In addition, simulation data of a pulse signal originating from a pile-up phenomenon may be generated through numerical calculation reproducing the inside of the nuclear reactor, and the group to which the generated simulation data of the pulse signal is allocated when inputted to the trained model 81 may be defined as a group 84 originating from a pile-up phenomenon. By executing learning as described above, the model generation unit 62 generates and outputs a trained model. The trained-model storage unit 21 stores the trained model outputted from the model generation unit 62.

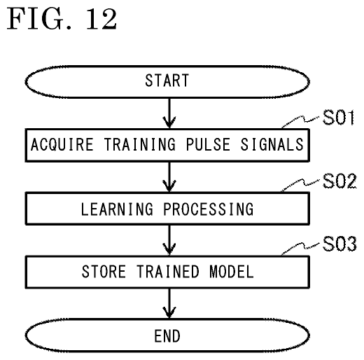

FIG. 12 is a flowchart illustrating processing by the learning device 60 and the trained-model storage unit 21 in embodiment 1. The flowchart in FIG. 12 relates to the learning processing in the learning device 60. Step S01 is a training pulse signal acquisition step, step S02 is a learning processing step, and step S03 is a trained model storage step.

In step S01, the training data acquisition unit 61 acquires training data including training pulse signals outputted from the detector 1, and outputs the training data to the model generation unit 62. Then, the process proceeds to step S02. In step S02, the model generation unit 62 learns pulse origins which are origins of the pulse signals as outputs, through so-called unsupervised learning, in accordance with the training data created on the basis of the pulse signals, thus generating a trained model, and outputs the generated trained model to the trained-model storage unit 21. Then, the process proceeds to step S03. In step S03, the trained-model storage unit 21 stores the trained model acquired from the model generation unit 62. Thus, the process is ended.

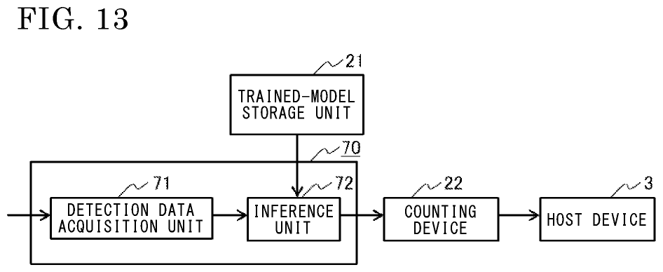

Next, the inference device 70 of the neutron measurement device 100 according to embodiment 1 will be described. FIG. 13 is a block diagram showing the configuration of the inference device 70 in embodiment 1. The inference device 70 includes a detection data acquisition unit 71 which acquires a detection pulse signal outputted from the detector 1 which is an ionization chamber or a proportional counter, and an inference unit 72 which outputs a pulse origin on the basis of the pulse signal acquired from the detection data acquisition unit 71, using the trained model for inferring a pulse origin which is an origin of the pulse signal, from the pulse signal.

The detection data acquisition unit 71 acquires a pulse signal which is an analog signal, outputted from the detector 1, and outputs a digital pulse signal obtained by converting the analog pulse signal to a digital signal, to the inference unit 72. A time width for converting the analog signal to the digital signal may be a time width including the entirety of the acquired pulse signal, and is, for example, a time width including a range from a rising time to a termination time of the acquired pulse signal. In addition, a time resolution for converting the analog signal to the digital signal may be a sufficient time resolution for the inference unit 72 to infer a pulse origin using the trained model stored in the trained-model storage unit 21, and may be the same as the time resolution for converting the analog signal to the digital signal in the training data acquisition unit 61.

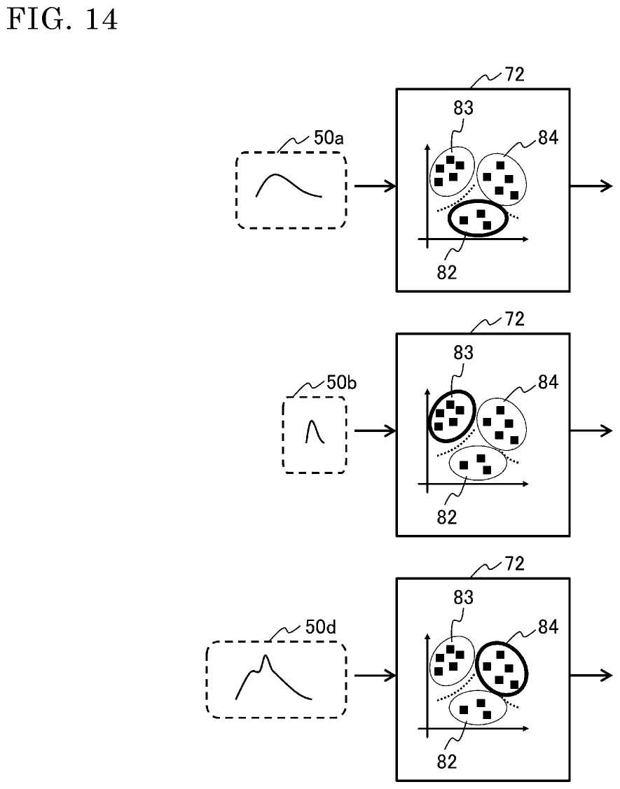

The inference unit 72 infers a pulse origin which is an origin of a pulse signal, using the trained model stored in the trained-model storage unit 21. That is, the inference unit 72 inputs the pulse signal acquired in the detection data acquisition unit 71, to the trained model, thereby inferring the cluster to which the inputted pulse signal belongs, and outputs the inference result as a pulse origin. FIG. 14 illustrates processing in the inference unit 72 in embodiment 1. For example, an upper diagram in FIG. 14 shows that, when the pulse signal 50a based on neutron detection is inputted to the inference unit 72, in the inference unit 72, the pulse signal 50a is classified into the group 82 originating from a neutron in the trained model 81 and a “neutron” is outputted as a pulse origin which is an inference result. A middle diagram in FIG. 14 shows that, when the pulse signal 50b based on gamma-ray detection is inputted to the inference unit 72, in the inference unit 72, the pulse signal 50b is classified into the group 83 originating from radiation other than a neutron in the trained model 81 and “radiation other than a neutron” is outputted as a pulse origin which is an inference result. A lower diagram in FIG. 14 shows that, when the pulse signal 50d due to a pile-up phenomenon is inputted to the inference unit 72, in the inference unit 72, the pulse signal 50d is classified into the group 84 originating from a pile-up phenomenon in the trained model 81 and a “pile-up phenomenon” is outputted as a pulse origin which is an inference result.

In embodiment 1, the case where the inference unit 72 outputs a pulse origin using the trained model trained in the model generation unit 62 of the neutron measurement device 100, is shown. However, a trained model may be acquired from outside, e.g., another neutron measurement device, and a pulse origin may be outputted on the basis of the trained model.

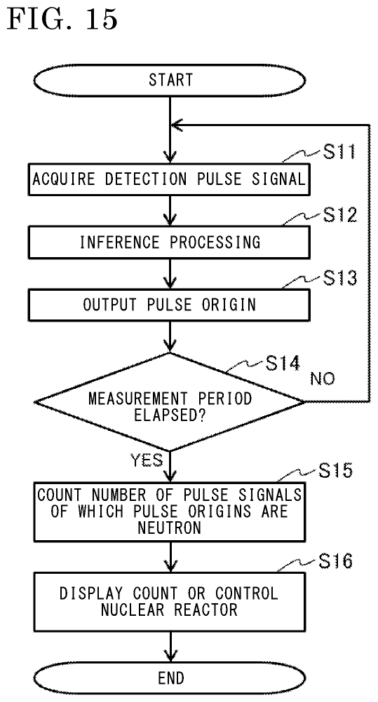

FIG. 15 is a flowchart illustrating processing by the inference device 70, the counting device 22, and the host device 3 in embodiment 1. Step S11 is a detection pulse signal acquisition step, step S12 is an inference processing step, step S13 is a pulse origin output step, step S14 is a measurement period confirmation step, step S15 is a count calculation step, and step S16 is a host device processing step.

In step S11, the detection data acquisition unit 71 acquires a detection pulse signal outputted from the detector 1, and outputs the detection pulse signal to the inference unit 72. Then, the process proceeds to step S12. In step S12, the inference unit 72 inputs the pulse signal acquired from the detection data acquisition unit 71 to the trained model stored in the trained-model storage unit 21, and obtains a pulse origin as an output. Then, the process proceeds to step S13. In step S13, the inference unit 72 outputs a pulse origin which is an output of the trained model, to the counting device 22. Then, the process proceeds to step S14. In step S14, the counting device 22 confirms whether or not a predetermined measurement period has elapsed. Then, if the measurement period has elapsed, the process proceeds to step S15, and if the measurement period has not elapsed, the process returns to step S11, to perform processing from step S11 to step S13 again. In step S15, the counting device 22 counts the number of pulse signals of which the pulse origins received from the inference unit 72 are a neutron within the measurement period, and outputs the obtained count to the host device 3. Then, the process proceeds to step S16. In step S16, the host device 3 displays the count acquired from the counting device 22 or controls the nuclear reactor on the basis of the count acquired from the counting device 22. Thus, the process is ended.

Through repetition of the processing from step S11 to step S13, the counting device 22 may count the number of pulse signals of which the pulse origins acquired and received from the inference unit 72 are a neutron within a predetermined measurement period, and output the obtained count to the host device 3. Alternatively, through repetition of the processing from step S11 to step S13, in a predetermined measurement interval, the counting device 22 may output a value obtained by dividing the count of pulse signals of which the pulse origins are a neutron within the time of the measurement interval, by the time of the measurement interval, as a count rate. The measurement period or the measurement interval may be, for example, such a length that the neutron measurement device can respond in consideration of a period from when a signal for performing protection operation of the nuclear reactor is detected and transmitted to the host device 3 until various calculations are performed for determination and a control rod is inserted so as to ensure protection of the reactor core. In general, the length is several milliseconds to several hundreds of milliseconds.

With the above processing, it is possible to exclude a case where a pulse signal originating from a pile-up phenomenon is erroneously detected as a neutron. As a result, a count of pulse signals of which the pulse origins are a neutron can be acquired, and an erroneous count due to pulse signals originating from a pile-up phenomenon can be excluded. Thus, it is possible to monitor the nuclear reactor output with high accuracy without overestimating or underestimating.

In the above description, unsupervised learning is applied to the learning algorithm used in the model generation unit 62 or the inference unit 72. However, the learning algorithm is not limited thereto. Instead of unsupervised learning, a method such as reinforcement learning, supervised learning, or semi-supervised learning may be applied to the learning algorithm. As the learning algorithm used in the learning device 60, deep learning for learning about extraction of feature quantities may be used or another known method may be used. A method for realizing the unsupervised learning is not limited to non-hierarchical clustering such as the K-means clustering shown above, and may be any known method that enables clustering. For example, hierarchical clustering such as a nearest neighbor method may be used. In a case of realizing supervised learning, for example, through numerical calculation reproducing the inside of the nuclear reactor, a pulse signal based on neutron detection, a pulse signal based on gamma-ray detection, and a pulse signal based on alpha-ray detection, and a pulse signal based on a pile-up phenomenon may be generated as simulation data and these pulse signals may be used as training data in which pulse origins have been known.

In embodiment 1, the detector 1 may output a pulse signal that is a digital signal, and the learning device 60 and the inference device 70 may be connected to the detector 1 or the counting device 22 via a network. The learning device 60 and the inference device 70 may be provided in the neutron measurement device 100. Further, the detector 1 may output a pulse signal that is a digital signal, and the learning device 60 and the inference device 70 may be present on a cloud server. In a case where the learning device 60 and the inference device 70 are connected to the detector 1 or the counting device 22 via a network, or in a case where the learning device 60 and the inference device 70 are present on a cloud server, the training data acquisition unit 61 and the detection data acquisition unit 71 acquire a pulse signal that is a digital signal.

The model generation unit 62 may learn origins that cause inputted pulse signals in accordance with training data created with respect to a plurality of neutron measurement devices. The model generation unit 62 may acquire training data from a plurality of neutron measurement devices used in the same area or may use training data collected from a plurality of neutron measurement devices which operate independently in different areas, to learn origins that cause inputted pulse signals. As another example, the model generation unit 62 may learn origins that cause inputted pulse signals in accordance with training data created from pulse signals of a neutron measurement device obtained through numerical calculation reproducing the inside of the nuclear reactor. In addition, a neutron measurement device for collecting training data may be added as a target or may be removed from targets, at any point of time during processing. Further, the learning device 60 that has learned origins that cause inputted pulse signals with regard to a certain neutron measurement device may be applied to an origin that causes an inputted pulse signal in another device, and on the basis of the origin that causes the inputted pulse signal in the other device, the learning device 60 may undergo learning again to update origins that cause inputted pulse signals.

As described above, the learning device 60 according to embodiment 1 is the learning device 60 that obtains a trained model for inferring a pulse origin which is an origin of a pulse signal in the neutron measurement device 100 using a pulse measurement method, the learning device 60 including: the training data acquisition unit 61 which acquires training data including the pulse signal outputted from the detector 1 which is an ionization chamber or a proportional counter; and a model generation unit 62 which generates the trained model for inferring the pulse origin from the pulse signal outputted from the detector 1, using the training data. Thus, it is possible to exclude a case where a pulse signal originating from a pile-up phenomenon is erroneously detected as a neutron.

### Embodiment 2

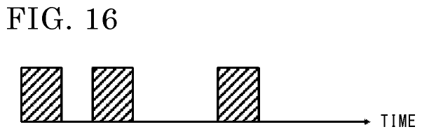

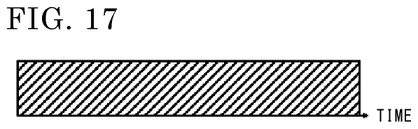

First, a time at which a pulse signal outputted from the detector 1 occurs will be described. FIG. 16 shows a time at which a neutron due to nuclear fission in a nuclear reactor occurs. In FIG. 16, the horizontal axis indicates time, and a hatched part indicates that a neutron has occurred at a time indicated on the horizontal axis. As shown in FIG. 16, neutrons produced due to a nuclear fission reaction discretely occur in the nuclear reactor. In the nuclear reactor in operation, neutrons fly around and some of the neutrons are captured and measured by a detector. Here, in a case where nuclear fission does not occur, production and movement of a neutron in the nuclear reactor occur randomly, and therefore a neutron is measured independently at any timing. On the other hand, in a case where nuclear fission occurs, a set of neutrons in the same generation which have been produced starting from one neutron through chain reaction of nuclear fission flies around in the nuclear reactor and thus neutrons occur discretely. That is, in neutron measurement, neutrons can be consecutively measured at a timing when a set of neutrons is produced, whereas no neutrons can be measured at a timing when such a set of neutrons is not produced. Meanwhile, FIG. 17 shows a time at which radiation other than a neutron in the nuclear reactor occurs. In FIG. 17, the horizontal axis indicates time, and a hatched part indicates that radiation other than a neutron is produced at a time indicated on the horizontal axis. As shown in FIG. 17, radiation other than a neutron is always produced from the nuclear reactor. From FIG. 16 and FIG. 17, it is found that pulse signals due to pile-up phenomena outputted from the detector 1 at times indicated at hatched parts in FIG. 16 include a large number of pulse signals due to pile-up phenomena including a neutron. Therefore, the neutron measurement device according to embodiment 2 uses a trained model for inferring a pulse origin from a pulse signal and an acquisition time which is a time at which a pulse signal has been acquired from the detector 1.

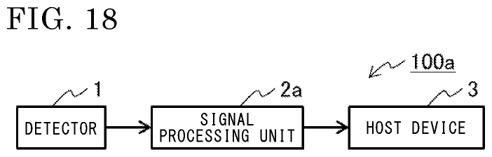

FIG. 18 is a block diagram showing the configuration of a neutron measurement device 100a according to embodiment 2. The neutron measurement device 100a according to embodiment 2 shown in FIG. 18 has a signal processing unit 2a instead of the signal processing unit 2, as compared to the neutron measurement device 100 according to embodiment 1 shown in FIG. 1. The other configurations of the neutron measurement device 100a according to embodiment 2 is the same as that of the neutron measurement device 100 according to embodiment 1.

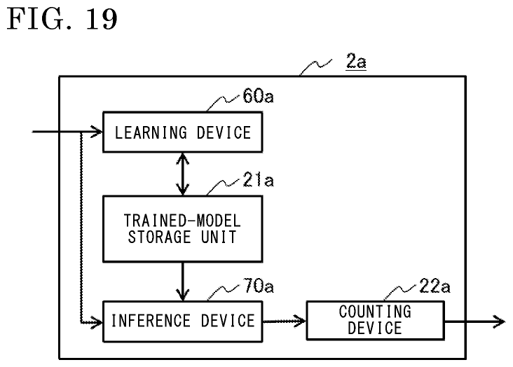

FIG. 19 is a block diagram showing the configuration of the signal processing unit 2a in embodiment 2. The signal processing unit 2a in embodiment 2 shown in FIG. 19 has a learning device 60a instead of the learning device 60, a trained-model storage unit 21a instead of the trained-model storage unit 21, an inference device 70a instead of the inference device 70, and a counting device 22a instead of the counting device 22, as compared to the signal processing unit 2 in embodiment 1 shown in FIG. 9.

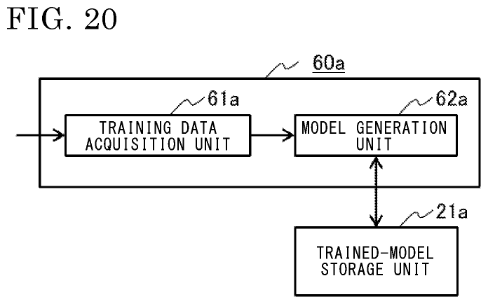

FIG. 20 is a block diagram showing the configuration of the learning device 60a in embodiment 2. The learning device 60a in embodiment 2 shown in FIG. 20 has a training data acquisition unit 61a instead of the training data acquisition unit 61, and a model generation unit 62a instead of the model generation unit 62, as compared to the learning device 60 in embodiment 1 shown in FIG. 10.

The training data acquisition unit 61a acquires a pulse signal that is an analog signal, outputted from the detector 1. Further, the training data acquisition unit 61a acquires information about an acquisition time which is a time at which the training data acquisition unit 61a has acquired the pulse signal from the detector 1. The training data acquisition unit 61a may acquire information about the acquisition time from an external clock at the timing when the training data acquisition unit 61a has acquired the pulse signal from the detector 1, or may have an internal clock to acquire information about the acquisition time. The training data acquisition unit 61a outputs a set of the acquired pulse signal and acquisition time as training data to the model generation unit 62a.

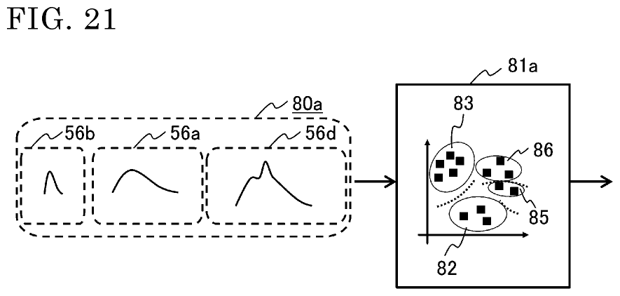

The model generation unit 62a generates a trained model for inferring a pulse origin which is an origin of the pulse signal, from the pulse signal and the acquisition time, using the training data including the set of the pulse signal and the acquisition time outputted from the training data acquisition unit 61a. FIG. 21 illustrates an example of unsupervised learning in the model generation unit 62a in embodiment 2. A trained model 81a in embodiment 2 is for inferring, from the pulse signal and the acquisition time outputted from the detector 1, a pulse origin which is an origin of the pulse signal, as any of a neutron, radiation other than a neutron, a pile-up phenomenon including a neutron, or a pile-up phenomenon including no neutron. The model generation unit 62a learns origins of pulse signals through so-called unsupervised learning in accordance with a classification method by K-means clustering, for example.

In the learning device 60a in embodiment 2, pulse origins which are origins of pulse signals are learned through so-called unsupervised learning in accordance with training data created on the basis of pulse signals and acquisition times acquired by the training data acquisition unit 61a. In the learning device 60a of embodiment 2, for example, as shown in FIG. 21, pulse origins which are origins of pulse signals are learned through so-called unsupervised learning in accordance with training data 80a including pulse signals 56a based on neutron detection with acquisition times, pulse signals 56b based on gamma-ray detection with acquisition times, and pulse signals 56d due to a pile-up phenomenon with acquisition times, and are classified into four groups, i.e., the group 82 originating from a neutron, the group 83 originating from radiation other than a neutron, a group 85 originating from a pile-up phenomenon including a neutron, and a group 86 originating from a pile-up phenomenon including no neutron. In the learning device 60a of embodiment 2, using information about acquisition times, the group 84 originating from a pile-up phenomenon is divided into two groups, i.e., the group 85 originating from a pile-up phenomenon including a neutron and the group 86 originating from a pile-up phenomenon including no neutron.

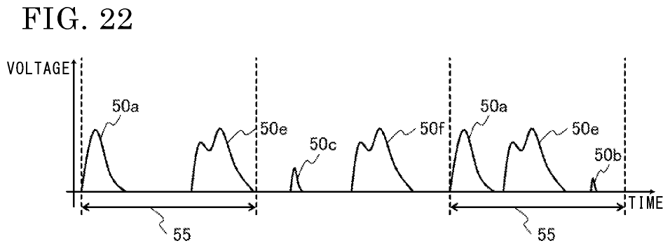

FIG. 22 illustrates discrimination processing for pulse signals due to pile-up phenomena in the learning device 60a of embodiment 2. FIG. 22 shows output signals from the detector 1 in FIG. 18, with the horizontal axis indicating time and the vertical axis indicating voltage. In FIG. 22, it is indicated that, from the detector 1, a pulse signal 50a based on neutron detection, a pulse signal due to a pile-up phenomenon, a pulse signal 50c based on alpha-ray detection, a pulse signal due to a pile-up phenomenon, a pulse signal 50c based on alpha-ray detection, a pulse signal due to a pile-up phenomenon, a pulse signal 50a based on neutron detection, a pulse signal due to a pile-up phenomenon, and a pulse signal 50b based on gamma-ray detection, are outputted in this order. The training data acquisition unit 61a acquires each of the pulse signals shown in FIG. 22, acquires a rising time of each pulse signal as an acquisition time which is a time at which the pulse signal has been acquired, and outputs sets of the acquired pulse signals and acquisition times as training data.

Regarding discrimination of pulse signals due to pile-up phenomena in the model generation unit 62a, a neutron measurement period 55 is set in advance, a pulse signal due to a pile-up phenomenon detected during the neutron measurement period 55 from the rising time of the pulse signal 50a based on neutron detection is defined as a pulse signal 50e due to a pile-up phenomenon including a neutron, and a group including the pulse signal 50e due to a pile-up phenomenon including a neutron is defined as the group 85 originating from a pile-up phenomenon including a neutron. In addition, a pulse signal due to a pile-up phenomenon detected at a time that is not during the neutron measurement period 55 from the rising time of the pulse signal 50a based on neutron detection is defined as a pulse signal 50f due to a pile-up phenomenon including no neutron, and a group including the pulse signal 50f due to a pile-up phenomenon including no neutron is defined as the group 86 originating from a pile-up phenomenon including no neutron.

The neutron measurement period 55 is, for example, a neutron life. The neutron life is an average period during which a neutron is present in the nuclear reactor from when the neutron is produced through nuclear fission in the nuclear reactor to when the neutron disappears by being absorbed or leaked to the outside of the nuclear reactor, and the neutron life is obtained by dividing the total number of neutrons in the nuclear reactor by the number of neutrons that disappear per unit time. Some of the neutrons that have disappeared are absorbed into fuel and cause nuclear fission, to produce neutrons in the next generation. The neutron life which is a time interval between nuclear reaction in one generation and nuclear reaction in the next generation is 0.05 seconds to 0.07 seconds in a general light-water reactor. Therefore, the neutron measurement period 55 is assumed to be 0.05 seconds to 0.07 seconds. Most of pile-up phenomena that occur during the neutron measurement period 55 from the rising time of the pulse signal 50a based on neutron detection are due to neutrons. Accordingly, in the learning device 60a of embodiment 2, it is assumed that a pulse signal due to a pile-up phenomenon detected during the neutron measurement period 55 from the rising time of the pulse signal 50a based on neutron detection is included, as the pulse signal 50e due to a pile-up phenomenon including a neutron, in the group 85 originating from a pile-up phenomenon including a neutron. In addition, most of pile-up phenomena that occur at times that are not during the neutron measurement period 55 from the rising time of the pulse signal 50a based on neutron detection are not due to neutrons. Accordingly, in the learning device 60a of embodiment 2, it is assumed that a pulse signal due to a pile-up phenomenon detected at a time that is not during the neutron measurement period 55 from the rising time of the pulse signal 50a based on neutron detection is included, as the pulse signal 50f due to a pile-up phenomenon including no neutron, in the group 86 originating from a pile-up phenomenon including no neutron.

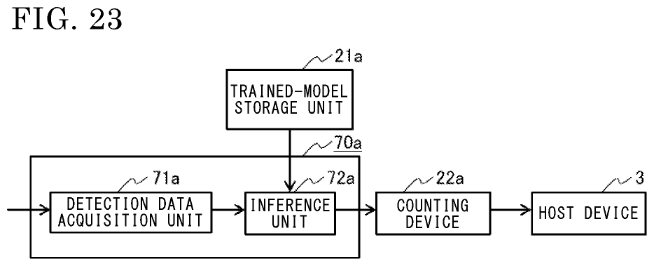

FIG. 23 is a block diagram showing the configuration of the inference device 70a in embodiment 2. The inference device 70a in embodiment 2 shown in FIG. 23 has a detection data acquisition unit 71a instead of the detection data acquisition unit 71, and an inference unit 72a instead of the inference unit 72, as compared to the inference device 70 in embodiment 1 shown in FIG. 13.

The detection data acquisition unit 71a acquires a pulse signal that is an analog signal, outputted from the detector 1, and acquires information about the acquisition time which is a time at which the detection data acquisition unit 71a has acquired the pulse signal from the detector 1. The detection data acquisition unit 71a may acquire information about the acquisition time from an external clock at the timing when the detection data acquisition unit 71a has acquired the pulse signal from the detector 1, or may have an internal clock to acquire information about the acquisition time. The detection data acquisition unit 71a outputs a set of the acquired pulse signal and acquisition time to the inference unit 72a.

The inference unit 72a infers a pulse origin which is an origin of the pulse signal, using the trained model stored in the trained-model storage unit 21a. The pulse origin outputted from the inference unit 72a is any of a neutron, radiation other than a neutron, a pile-up phenomenon including a neutron, or a pile-up phenomenon including no neutron. The counting device 22a counts the number of pulse signals of which the pulse origins received from the inference unit 72a are a neutron or a pile-up phenomenon including a neutron within a predetermined measurement period, and outputs the obtained count to the host device 3. The host device 3 displays the count acquired from the counting device 22a or controls the nuclear reactor on the basis of the count acquired from the counting device 22a.

As described above, the learning device 60a according to embodiment 2 is the learning device 60a that obtains a trained model for inferring a pulse origin which is an origin of a pulse signal in the neutron measurement device 100a using a pulse measurement method, the learning device 60a including: the training data acquisition unit 61a which acquires training data including the pulse signal outputted from the detector 1 which is an ionization chamber or a proportional counter; and the model generation unit 62a which generates a trained model for inferring the pulse origin from the pulse signal outputted from the detector 1, using the training data. The training data acquisition unit 61a acquires the training data including time information which is a time at which the training data acquisition unit 61a has acquired the pulse signal outputted from the detector 1, and the model generation unit 62a generates the trained model for inferring the pulse origin from the pulse signal and the time information, using the training data. Thus, it is possible to count both of pulse signals based on neutrons and pulse signals due to pile-up phenomena including a neutron, whereby neutron detection can be performed with high accuracy.

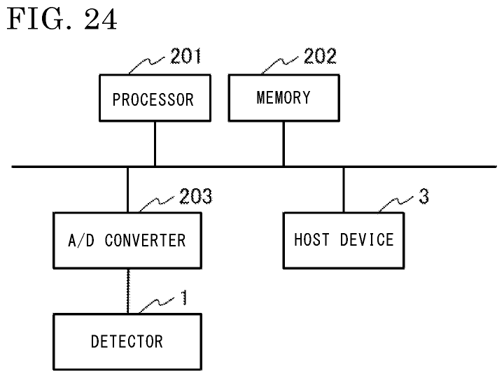

FIG. 24 is a schematic diagram showing an example of a hardware configuration of the neutron measurement device according to each of embodiments 1 and 2. The model generation unit 62, 62a, the inference unit 72, 72a, and the counting device 22 are implemented by a processor 201 such as a central processing unit (CPU) executing a program stored in a memory 202. The training data acquisition unit 61, 61a and the detection data acquisition unit 71, 71a are implemented by an A/D converter 203 and the processor 201 such as a central processing unit (CPU) executing a program stored in the memory 202. The memory 202 is used also as a temporary storage device in each processing executed by the processor 201. The above functions may be executed by a plurality of processing circuits coordinating with each other. The above functions may be implemented by dedicated hardware. In a case of implementing the above functions by dedicated hardware, the dedicated hardware is, for example, a single circuit, a complex circuit, a programmed processor, an ASIC, an FPGA, or a combination thereof. The above functions may be implemented by a combination of dedicated hardware and software or a combination of dedicated hardware and firmware. The memory 202 is, for example, a nonvolatile or volatile semiconductor memory such as a RAM, a ROM, a flash memory, or an EPROM, a magnetic disk, an optical disc, or a combination thereof. The trained-model storage unit 21, 21a is implemented by the memory 202. The detector 1 is connected to the A/D converter 203, and the processor 201, the memory 202, the A/D converter 203, and the host device 3 are connected via a bus.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 detector
2, 2a signal processing unit
3 host device
11 detector housing
12 gas
13 uranium-coated layer
14 electrode
15 insulator
16 electronic circuit
21, 21a trained-model storage unit
22, 22a counting device
40a neutron
40b gamma ray
41a nuclear fission product
41b electron
41c alpha ray
42 ion group
43 electron group
50a pulse signal based on neutron detection
50b pulse signal based on gamma-ray detection
50c pulse signal based on alpha-ray detection
50d pulse signal due to pile-up phenomenon
50e pulse signal due to pile-up phenomenon including neutron
50f pulse signal due to pile-up phenomenon including no neutron
51a rising period
52 threshold
53a line
53b, 53c curve
55 neutron measurement period
56a pulse signal based on neutron detection with acquisition time
56b pulse signal based on gamma-ray detection with acquisition time
56d pulse signal due to pile-up phenomenon with acquisition time
60, 60a learning device
61, 61a training data acquisition unit
62, 62a model generation unit
70, 70a inference device
71, 71a detection data acquisition unit
72, 72a inference unit
80, 80a training data
81, 81a trained model
82 group originating from neutron
83 group originating from radiation other than neutron
84 group originating from pile-up phenomenon
85 group originating from pile-up phenomenon including neutron
86 group originating from pile-up phenomenon including no neutron
100, 100a neutron measurement device
201 processor
202 memory
203 A/D converter

1. A learning device that obtains a trained model for inferring a pulse origin which is an origin of a pulse signal in a neutron measurement device using a pulse measurement method, the learning device comprising:
a training data acquisition circuitry which acquires training data including the pulse signal outputted from a detector which is an ionization chamber or a proportional counter; and
a model generation circuitry which generates the trained model for inferring the pulse origin from the pulse signal outputted from the detector, using the training data.

2. The learning device according to claim 1, wherein the training data acquisition circuitry acquires the training data including time information which is a time at which the training data acquisition circuitry has acquired the pulse signal outputted from the detector, and
the model generation circuitry generates the trained model for inferring the pulse origin from the pulse signal and the time information, using the training data.

3. A neutron measurement device using a pulse measurement method, comprising:
a detector which is an ionization chamber or a proportional counter;
a detection data acquisition circuitry which acquires a pulse signal outputted from the detector;
an inference circuitry which, using a trained model for inferring, from the pulse signal, a pulse origin which is an origin of the pulse signal, outputs the pulse origin on the basis of the pulse signal acquired by the detection data acquisition circuitry; and
a counting device which outputs a count of the pulse signals of which the pulse origins are a neutron.

4. The neutron measurement device according to claim 3, wherein
the detection data acquisition circuitry acquires an acquisition time which is a time at which the detection data acquisition circuitry has acquired the pulse signal outputted from the detector,
using the trained model for inferring the pulse origin from the pulse signal and the acquisition time, the inference circuitry outputs the pulse origin on the basis of the pulse signal and the acquisition time acquired by the detection data acquisition circuitry, and
the counting device outputs a count of the pulse signals of which the origins are a neutron or a pile-up phenomenon including a neutron.
